(19) United States
(12) Patent Application Publication
(10) Pub. No.: US 2013/0099580 A1
(43) Pub. Date: Apr. 25, 2013

(54) SOLAR POWER PLANT WITH INCREASED OPERATING LIFE

(71) Applicants: Uffe Borup, Sydals (DK); Frerk Haase, Harrislee (DE)

(72) Inventors: Uffe Borup, Sydals (DK); Frerk Haase, Harrislee (DE)

(73) Assignee: Danfoss Power Electronics A/S, Graasten (DK)

(21) Appl. No.: 13/702,087

(22) PCT Filed: Jun. 9, 2011
(86) PCT No.: PCT/DK2011/000059

§ 371 Date: Jan. 14, 2013

(30) Foreign Application Priority Data
Jun. 9, 2010 (DE) 10 2010 023 262.9

(51) Int. Cl. H02J 1/00

(52) U.S. Cl. CPC H02J 1/00
USPC 307/82; 307/83

(57) ABSTRACT

The invention relates to an arrangement having at least one electric potential-varying device for varying the electric potential of at least one electrical device with respect to earth potential, and a plant room facility. In the operating state, the electric potential-varying device is disposed in the plant room facility.

### CROSS REFERENCE TO RELATED APPLICATIONS

This application is entitled to the benefit of and incorporates by reference essential subject matter disclosed in International Patent Application No. PCT/DK2011/000059 filed on Jun. 9, 2011 and German Patent Application No. 10 2010 023 262.9 filed Jun. 9, 2010.

### FIELD OF THE INVENTION

The invention concerns an arrangement (technical arrangement) that comprises at least one electric potential-varying device for varying the electric potential of at least one electrical device in relation to earth potential.

### BACKGROUND

Particularly because of environmental problems and partly also because of the public subsidies concerned, the number of solar power plant generating electric power from sunlight with the direct use of photovoltaic elements is steadily increasing. The size of the plant can range from relatively small plant, for example on the roof of a house for the (partial) supply of a one-family or apartment house with electric power, to large power plant with a power output of several megawatt or more.

As, on the one hand, the design of photovoltaic cells only permits generation of direct current, and on the other hand electrical consumers are today usually designed for alternating voltage (typically 230 V/50 Hz or 110 V/60 Hz), it is necessary to initially convert the electrical direct current generated by the photovoltaic cells to alternating current. In state of the art plant, so-called inverters are used for this purpose today. A further advantage of generating alternating voltage is (particularly in connection with large solar power plant) that alternating voltage can be transformed, meaning that with correspondingly high voltage the electric current can also be transported over relatively large distances without excessive losses.

In practice, it has turned out that under certain circumstances solar power plant may experience unexpected early deterioration of the efficiency of the solar cells or even a degradation of solar cells to such a degree that the solar cells fail completely.

This is particularly the case when so-called thin-film solar cells are used. Even though the basic processes are not completely understood yet, practice has shown that this problem particularly occurs when (parts of) the solar cells are operated at a negative bias in relation to the environment. This gives rise to electrical fields against the anticipated field direction. In the case of thin-film solar cells this effect is non-reversible. Accordingly, a degradation or damage of the solar cell occurs.

Also with backside contacted or back-contact solar cells similar problems occur. In practice it has turned out that during operation of backside contacted solar cells an unfavourable electric potential can quickly deteriorate the efficiency. This is known as the so-called “polarisation effect”. With backside contacted solar cells, an unfavourable electric potential exists, when parts of the backside contacted solar cell is operated with a positive bias in relation to its environment. Even though the polarisation effect is usually reversible, it is desirable to avoid the relatively time-consuming regeneration phases.

In order to avoid degradations, deteriorations, deteriorations of the efficiency or damage caused by this, the state of the art already proposed to use a voltage source to bring parts of the solar power plant, particularly the solar cells, to a certain potential in relation to earth. This is particularly possible because usually the transformers, which have to be provided anyway, also have galvanically separating properties. Thus, a bias can be provided without having to consider the electrical transmission lines. Even if a transformer were not required, a galvanic separator (whose design is similar to that of a voltage transforming transformer) could still be used to provide substantially random biases here. Such systems are, for example, described in the German utility model DE 20 2006 008 936 U1, the US patent application US 2009/0101191 A1, the European patent EP 2 136 449 B1 and the international publication WO 2010/051812 A1.

Even though the systems described here are generally functional, they still have disadvantages. For example, the direct voltage sources described are mostly relatively numerous, expensive, time-consuming and complex. This does not only go for the sources themselves, but also for the installation. Often, the protection against failures, vandalism and/or theft is not sufficient either. Further, a remote control of the direct voltage sources used is often difficult.

### SUMMARY

The task of the invention is to provide an arrangement that is improved in relation to the state of the art, comprising at least one electric potential-varying device.

This task is solved by the invention.

It is proposed that an arrangement comprising at least one potential-varying device for varying the electric potential of at least one electrical device in relation to earth potential, and additionally comprising at least one plant room facility, is made so that during operation the electric potential-varying device is arranged at least partially in the at least one plant room facility. In such installations it is usually required anyway to have an plant room facility. Usually, this plant room facility will have sufficient space available for accommodating further components. Even in the case that the size of the plant room facility has to be planned (slightly) larger, the cost involved in this will increase significantly less than the increase in the available space or room. If, however, the electric potential-varying device is arranged in such an plant room, it is, for example, possible that the housing of the electric potential-varying device can be made in a simpler and more cost-efficient way. Also further advantages can result from the proposed embodiment in a simple manner. For example, plant room facilities are usually provided at central locations or for central and/or essential technical components. Therefore, if the electric potential-varying device is (partly) provided in an plant room facility, the potential-varying device will usually also be located in or adjacent to such a central location. This, for example, makes it simpler to provide an external control (for example according to the remote control principle and/or by manual intervention). In particular, it will often be possible to use components which are required anyway. Further, it will under certain circumstances be possible to reduce the number of cables to be run, which will not only reduce the cost for the cables, but also the cost for the cable running. Besides, caused by the plant room facility, the protection against environmental effects, vandalism, interferences or theft will usually be improved. This can provide the whole device with a higher operation safety. A particular advantage of a central location (in particular electrically, but under certain circumstances additionally or alternatively also geometrically) of at least one electric potential-varying device can occur, when in real systems (protective) switches and/or fuses are provided (which is usually the case). If, for example, one of the provided fuses fails, a central location of the electric potential-varying device will merely cause electrical separation of the system part located after the fuse in question. If, however, the at least one potential-varying device was located in a “side branch”, almost all system parts (apart from the side branch) would be electrically separated from the electric potential-varying device on fuse failure, which would usually be far more disadvantageous.

The location of the potential-varying device inside the plant room facility also permits protection of the potential-varying device against, for example, external temperature influences. In particular, when a battery is provided, the operation safety of the device can be improved. It is also possible to provide the potential-varying device, particularly a battery provided therefor, with larger dimensions, in order to ensure larger safety margins in this manner.

It is preferred that the at least one plant room facility is, at least partly, made as a building facility and/or as a lockable facility and/or located at a central location. A building facility may, for example, exist in the form of a small but (for example a transformer house as known per se), a container facility, a cellar facility and/or, in some cases, a locked room in a large building. Independently of this, the building facility design can provide a particularly good weather protection, a particularly good protection against vandalism and other damages, but also a protection against accidental touching and the like. Often, such building facilities are provided anyway in connection with solar power plant and other technical plant, in particular for the accommodation of specific technical instruments (for example transformers, conversion electronics etc.), but also to be used as control room and/or rest room. Basically, however, the plant room facility can also have a different design, for example a control cabinet or the like. A lockable facility is particularly to be understood as a protection by means of a lock (mechanical lock, electronic access) and the like. Depending on the kind of locking mechanism, different safety levels can be realised. Locating the plant room facility at a central spot can shorten the distances (both for running of cables and for the operating staff that can be in the immediate vicinity, in particular when specific monitoring tasks have to be performed).

It is advantageous if the at least one plant room facility serves the purpose of at least partly accommodating further components, particularly transformer devices and/or inverter devices. This is particularly cost-saving, as the plant room facility has to be provided anyway for the components mentioned, for example to meet the protection obligation towards passers-by (particularly protection against unwanted touching). Usually, the electric potential-varying device can be accommodated in the plant room facility without further modification. In some cases, however, it may turn out to be necessary to provide an plant room facility with slightly larger dimensions than usual. Further, particularly transformer devices and/or inverter devices generate a certain amount of waste heat during operation. This waste heat can be used for heating purposes, particularly also for heating the electric potential-varying device. This can improve the failure safety, particularly when the electric potential-varying device comprises a battery.

In particular, it can prove to be particularly advantageous in connection with the proposed device, if the at least one plant room facility additionally serves the purpose of partly accommodating at least one transformer device and at least one inverter device. This design makes it possible to further reduce the number of plant room facilities to be provided and/or permits poorer quality of housings (for example housings for the inverter devices). In particular, a (partial) location of a corresponding device or of the corresponding devices inside an plant room facility will usually permit a substantial reduction of theft protection, vandalism protection, access protection and/or weather protection (compared to a location “in the field”). Usually, it even turns out to be (more than) sufficient to provide a simple touching protection against unwanted touching. The “proper” protection or the “proper” weather protection is provided by the plant room facility. However, the access to the plant room facility is usually restricted to correspondingly qualified and authorised personnel. A further advantage of the proposed design is that the waste heat of both inverter devices and transformer devices can be used to heat the potential-varying device, which can have corresponding (combination) advantages. Contrary to the previously featured opinion that if possible the inverter devices had to be arranged adjacent to the photovoltaic cell modules, in order to reduce energy transfer losses, the inventors have surprisingly found out that—particularly with a corresponding, appropriate grouping of the photovoltaic cell modules—this disadvantage does usually not occur, and can under certain circumstances even be an advantage. If, for example, a corresponding number of photovoltaic cell modules are connected to each other in an appropriate manner, voltages in the range of about 1000 V are to be transferred. Therefore, usually the ohmic resistance of the corresponding transfer cable is of less importance. Contrary to this, when merely a “simple” inverter device (that does not additionally transform the voltage) is connected between the photovoltaic cell module and the transformer device, the inventors have surprisingly established that the inverter device can cause a voltage loss (for example caused by transformer losses). So, locating an inverter device adjacent to the photovoltaic cell modules would on the contrary result in an increase in the energy transfer losses. Accordingly, it may be particularly advantageously to arrange inverter device(s), transformer device(s) and potential-varying device(s) as close to each other as possible.

It is particularly preferred, if the arrangement comprises at least parts of a photovoltaic plant, like, in particular, at least one transformer device, at least one inverter device, at least one photovoltaic cell, at least one photovoltaic cell module, at least one photovoltaic cell panel and/or at least one, preferably designed to be movable, support device, particularly for at least one photovoltaic cell, for at least one photovoltaic cell module and/or for at least one photovoltaic cell panel. Further preferred is the design of the arrangement as a photovoltaic power plant. As mentioned in the introduction, especially in photovoltaic plant, an unfavourable electric potential in relation to the earth potential can lead to premature efficiency deterioration, a premature degradation, a premature output loss, a premature wear or even a premature failure of the plant or of plant parts (particularly the photovoltaic cells). Therefore, the use of the arrangement is particularly advantageous in this connection. This is particularly the case, if, at least partly, thin-film photovoltaic cells and/or backside contacted photovoltaic cells are used as photovoltaic cells. Tests have shown that especially such thin-film photovoltaic cells or backside contacted photovoltaic cells can act in a particularly sensitive manner towards unfavourable electric potentials or unfavourable electrical fields. Usually, the photovoltaic cell is understood to be a unit that can be made from a wafer (usually by means of sawing). Typical diameters of photovoltaic cells are therefore in the range of 5 cm, 10 cm, 20 cm or 30 cm. Mostly, photovoltaic cells are not sold as single cells, but as so-called photovoltaic cell modules having a size of, for example 50×50 cm², in which several single photovoltaic cells are electrically and mechanically connected to each other in a holding frame. Photovoltaic panels are typically to be understood as arrangements comprising several photovoltaic cell modules. Photovoltaic panels can have sizes of several square metres.

It is particularly advantageous, if, in the arrangement, the at least one inverter device is made as a galvanically isolating inverter device and/or as a galvanically non-isolating inverter device and/or as a two-phase alternating current generating inverter device and/or as a three-phase alternating current generating inverter and/or as a multi-phase alternating current generating inverter device. Initial tests have shown that particularly the mentioned embodiments of the at least one inverter device can provide particularly large advantages. With a galvanically isolating inverter device, for example, it is possible that different areas of the solar cell system can be provided with a different potential. Due to the galvanically isolating inverter device, different areas of the solar cell fields are namely galvanically separated from each other, without requiring additional components. It is also possible that the solar cell areas and the current-conducting areas (particularly between inverter and transformer) can be provided with different potentials. This is usually particularly advantageous for determining isolation problems. If, however, galvanically non-isolating inverter devices are used, it is usually possible to work with a particularly small number of electric potential-varying devices (in some cases even with only one single potential-varying device), which can reduce the total cost for the system. In particular, the cost of a possible interconnection can be reduced. Two-phase alternating current, three-phase alternating current or multi-phase alternating current (in particular with four or more phases) can prove to be advantageous in dependence of the size of the solar cell field. Particularly in connection with alternating current, it is also particularly advantageous, if an electric potential varying device with a substantially random potential (that is, not merely an earthing opportunity) can be provided. The reason is that a suitable level of the potential can prevent or substantially reduce an unfavourable potential for the photovoltaic cells, also in connection with negative half-wave shares.

Further, it can turn out to be advantageous, if, in the arrangement, the electric potential of at least one negative voltage line and/or at least one positive voltage line and/or one alternating current voltage line and/or at least one neutral line is changed (or fixed). In this manner, particularly advantageous electric potentials for the photovoltaic cells or advantageous electrical fields in the photovoltaic cells can be realised, which can, in particular, have a positive influence on the service life of the system. Additionally or alternatively, this further development can particularly reduce the risk caused by static voltages for the operating staff, passersby or other persons.

It can be particularly advantageous, if, in the arrangement, the size of the potential displacement is changeable, at least partly and/or at least with regard to range, and is particularly time-dependent, light-intensity dependent, temperature-dependent, voltage-dependent, current-dependent and/or dependent on the control input of an interface device. In this manner, the system can become particularly flexible, durable and service-friendly. In particular, the input via an interface device can take place by means of manual input and/or remote input. In both cases, it is usually advantageous, if the electric potential-varying device is arranged adjacent to certain components, in particular transformers and/or inverter devices. Such components usually comprise input possibilities anyway (both for manual input and remote input). In this manner, it is, for example, possible to shorten or save data transfer lines, thus avoiding data transfer errors. Of course, it is also possible that the interface device can transfer data in both directions. Thus, for example, the direct voltage source can measure the applied “correction voltage” and transfer these measured values via the interface device. If required, the measured values can be transferred further via the data remote transfer lines.

Further, it can be advantageous, if, in the arrangement, at least parts of the photovoltaic cells, in particular parts of the photovoltaic cell modules and/or parts of the photovoltaic cell panels (if available) are grouped electrically in such a manner that the individual groups comprise, at least in certain areas, different current paths for the generated current. In this manner a particularly large fail safety and/or efficiency of the plant can be realised. In particular, it is, for example, possible that the grouping of the photovoltaic cells takes place in such a manner that these groups are based on the radiation intensity (which depends on the sun position). With such a grouping, the inverter or other measures, can receive the different sun radiation, and thus the differently generated electrical output, into consideration and/or balance it, so that the total efficiency of the total plant can increase substantially.

Further, it can be advantageous, if, in the arrangement, at least parts of at least one inverter are arranged adjacent to at least one photovoltaic device. In this way, particularly current line losses caused by a direct current transfer at relatively low voltage can be avoided. Due to the relatively low voltage, the current intensities are by the way correspondingly large. Accordingly, with the proposed embodiment, it is also possible to save particularly thick (and thus cost intensive) cables. This can substantially reduce the cost of the plant. Further, it must be mentioned that power electronics for inverters are only available or economically reasonable up to specific maximum outputs. Therefore, it is often required anyway to use a larger number of inverters. If each of these inverters is arranged adjacent to a certain group of photo-voltaic elements, the efficiency of the plant can be further increased, or the cost of the plant can be further reduced.

A further preferred embodiment of the arrangement may occur, if at least one switching device and/or at least one safety device is provided. It is preferred that at least one electric potential-varying device is arranged between the at least one switching device and/or the at least one safety device and at least one electrical device, for example at least one transformer device and/or at least one inverter device. In particular, if at least one switching device (that can be operated, for example, by operating staff, service staff and/or by remote control) is provided, it is possible that parts of the system can be electrically separated from the remaining parts of the system. Thus, for example, a small part of a solar power system can be turned off for maintenance purposes (for example replacement of solar cells, maintenance of solar cell holders, maintenance of inverters etc.). Still, however, it is possible for the solar power plant to continue generating electrical energy. In particular, if only a relatively small share of the solar power plant is turned off, the output decrease will often hardly be mentionable. Based on the principle of supply safety, such an embodiment is advantageous. The same applied for the provision of safety devices. In this connection, usually only a small part of the plant fails. The loss of generated energy from the failure until the repair is then relatively small. The proposed arrangement of the at least one electric potential-varying device in relation to the at least one electrical device as well as the at least one switching device and/or the at least one safety device usually turns out to be particularly advantageous, because usually the still functional (not turned off) parts of total plant can still be operated at a suitable (suitably set) electric potential. At the same time, a particularly large safety, particularly for the service staff and other persons, can be provided.

It is particularly preferred, if at least one safety turn-off device, in particular an earth leakage circuit breaker device, is provided in the plant for turning off the electric potential-varying device. In this manner, the protection of the operating staff, the service staff and other persons can be further improved. It can also be imagined that the safety turn-off device additionally or alternatively turns off other electrical components of the plant (for example the inverter, control motor etc.).

### BRIEF DESCRIPTION OF THE DRAWINGS

In the following, the invention is explained in detail by means of various embodiments with reference to the drawings, showing:

FIG. 1 is a first embodiment of a solar power plant in a schematic component view;

FIG. 2 is a second embodiment of a solar power plant in a schematic component view;

FIG. 3 is a third embodiment of a solar power plant in a schematic component view;

FIG. 4 is an embodiment of a substation in different schematic views.

### DETAILED DESCRIPTION

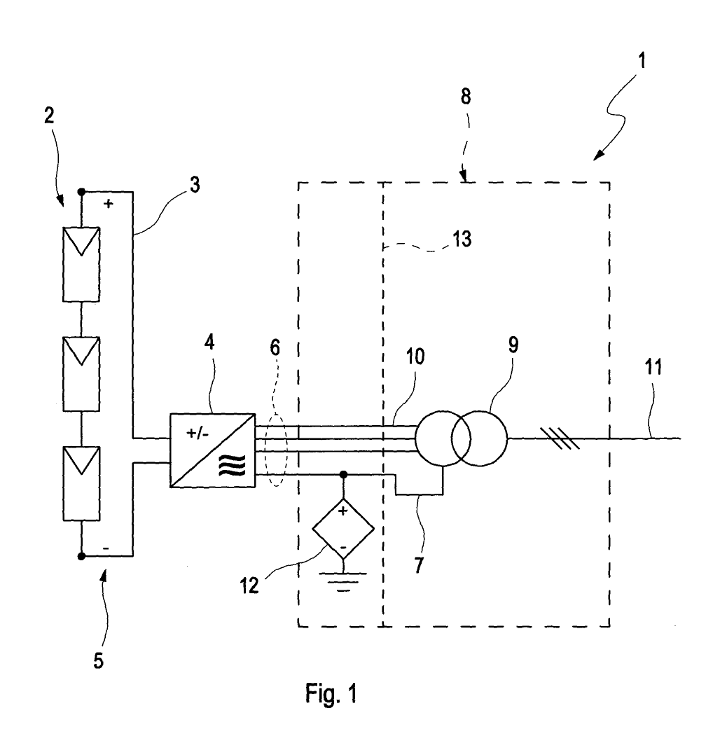

FIG. 1 shows a schematic component view of a possible, first embodiment of a solar power plant 1. The solar power plant comprises a large number of solar cells 2, which are only shown schematically in FIG. 1. The solar cells 2 have the form of commercially available solar cell modules. In the present embodiment, several solar cell modules have been assembled mechanically and electrically to solar cell panels. The solar cell panels again are typically mounted on holding poles (which are in some cases also mounted movably) with a suitable inclination.

The direct voltage generated by the solar cells 2 (plus pole in FIG. 1 at the top, minus pole in FIG. 1 at the bottom) is supplied to an inverter 4 via correspondingly dimensioned direct current cables 3. Based on the direct voltage 5, the inverter 4 generates an alternating voltage 6, in the present embodiment of the solar power plant 1 a three-phase alternating voltage 6 with separate neutral conductor 7. In the present embodiment, the inverter 4 has the form of a transformer-free inverter 4, which therefore acts in a galvanically non-isolating manner.

According to the present embodiment, the solar cells 2 and the inverter 4 are arranged “in the field”. Preferably, the inverter 4 is arranged in the immediate vicinity of the solar cells 2 in order to keep the losses of the direct voltage transfer 5 (that occurs at a relatively low voltage) through the direct current cable 3 low. For example, it is possible that the inverter 4 is mounted on a holder support for solar cell panels or on the reverse of solar cell panels. This is possible, because, thanks to the power electronics available today, the weight of modern inverters 4 has decreased drastically. The transfer of the three-phase alternating current 6 in the direction of the substation 8 (in FIG. 1 shown schematically by means of a dotted line), however, occurs at an increased voltage in the form of three-phase alternating current 6. Typically, the substation 8 and the solar cells 2 are arranged several 10 m up to several 100 m apart.

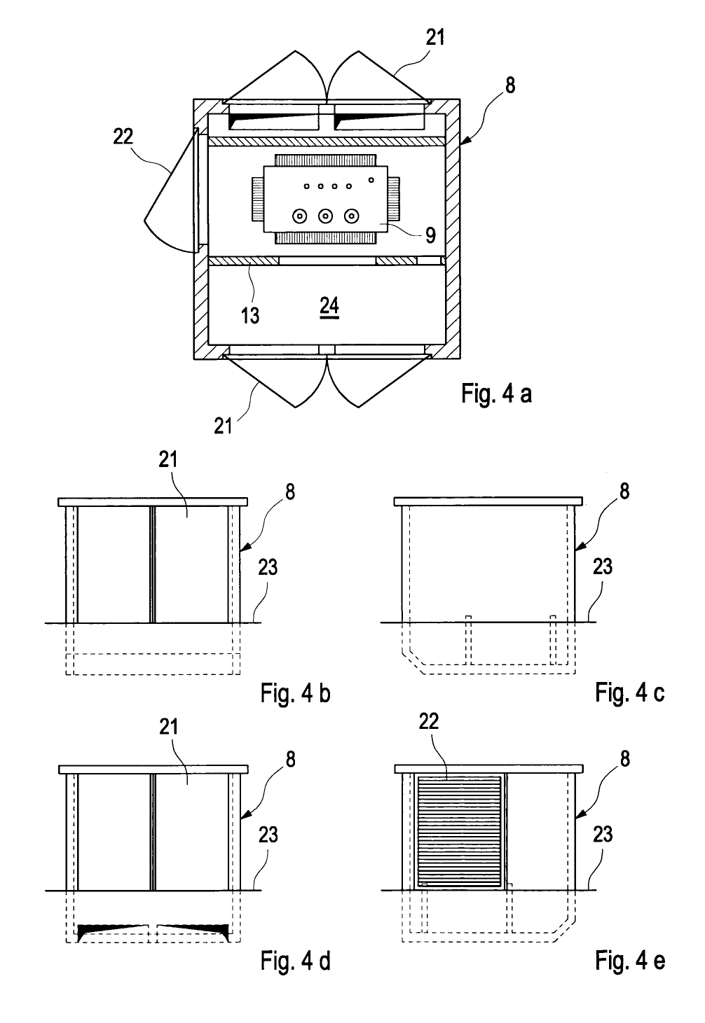

The substation 8 is, for example, a typical transformer house that can have a design that is typical for the country in question. A possible embodiment of such a substation 8 can be seen in FIG. 4. Typically, the substations 8 are made to be weather-proof (i.e. rain-proof etc.). Further, substations 8 are protected against undesired access by means of, for example, mechanical locks or electronic access mechanisms. As usual, if required, a transformer 9 is arranged in the substation 8 shown in FIG. 1, said transformer 9 transforming the three-phase alternating current 6 supplied through a cable 10 to a usually substantially higher voltage and supplying it via a high voltage outlet 11. For example, here voltages of up to several 10 KV can be concerned. Further, the transformer 9 acts as a galvanic isolation. Thus, the high voltage outlet 11 and the alternating current cable 10 (as well as the solar cells 2 via the inverter 4) are galvanically isolated from one another.

Since it has turned out that the use of thin-layer solar cells can cause a rapid deterioration of the efficiency of the solar cells 2, if these (partly) have a voltage lower than the surrounding earth potential, the present example provides a direct voltage source 12 (of the electric potential-varying device) that puts the neutral conductor 7 of the three-phase alternating current cable 10 to a defined potential that is higher than the earth potential. In this connection, the potential of the neutral conductor 7 is chosen so that at any time each individual phase of the three-phase alternating current 6 is kept higher than the earth potential or at least at the earth potential. Further, the voltage of the direct voltage source 12 is chosen so that also both poles of direct voltage 5 (in particular also the negative pole) are higher than the earth potential or at least equal to the earth potential. As mentioned above, the inverter 4 in FIG. 4 is of the non-galvanically isolating type, a suitable potential displacement for both the solar cells 2 and the alternating current cable 10 (including the inverter 4) can be varied by means of a single direct voltage source 12.

If, instead of thin-layer solar cells, backside contacted solar cells are used, it is required that, if possible, the electric potentials of the backside contacted solar cells are always lower than the earth potential (particularly also the positive pole of the backside contacted solar cells), in order to prevent a rapid deterioration of the efficiency.

Preferably, the direct voltage source 12 is designed so that it receives its energy need via the electrical energy generated by the solar power plant 1. Particularly for the bridging of overnight periods and the like, however, batteries may also be provided. Preferably, also the size of the voltage of the direct voltage source 12 can be variable and changeable by means of, for example, a timer (night operation), operator invention (for example a control panel) or remote control (for example data transfer net).

As shown in the present embodiment, the direct voltage source 12 is arranged in an area inside the substation 8 that is separated from the space for the transformer 9 by an intermediate wall 13. Therefore, the direct voltage source 12 can be provided with a substantially less expensive housing (usually a weather protection is not required), as the weather protection is provided by the housing of the substation 8. As the substation 8 is further protected against unwanted access, also the direct voltage source 12 is protected against unwanted manipulation, vandalism or theft. Further, the waste heat of the transformer 9 can be used to increase the operation reliability of the direct voltage source (in particular its battery), particularly in winter. Further, it must be noted that, according to the present state of the art, trans-formers 9 (or electrical contactors inside the substation 8) must be switched frequently (both by manual intervention and by remote control). If switching by manual intervention appears, the operator of the system cannot only switch the transformer 9, but at the same time also the direct voltage source 12. This may save cost of operation staff. Also in the case of remote control, the situation can be particularly simple, as the control lines provided for switching the transformer 9 can also be used for the control of the direct voltage source 12. As the direct voltage source 12 and the transformer 9 are located close to each other, the running of long data lines can be avoided, which can have particularly cost-efficient (or cost reducing) effects. Also, at least some components of the data remote transfer device can be arranged inside the substation 8, so that these can also be arranged in a weather-proof, theft-proof and vandalism-proof manner.

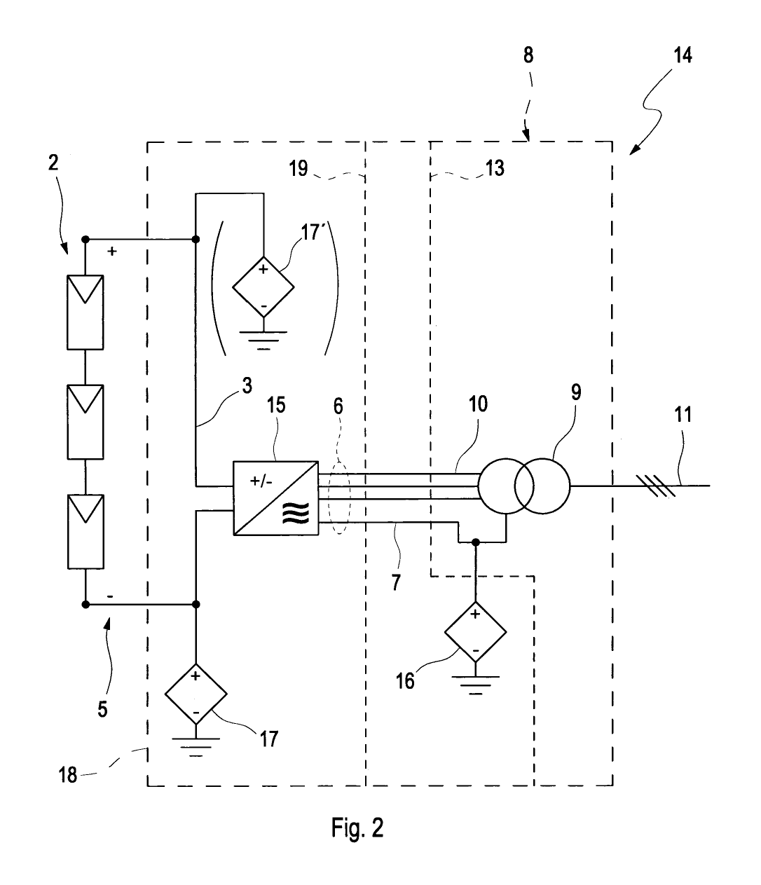

FIG. 2 shows a second embodiment of a solar power plant 14. The second embodiment of a solar power plant 14 resembles the embodiment shown in FIG. 1 of a solar power plant 1. However, in the presently shown embodiment of a solar power plant 14, a galvanically isolating inverter 15 is provided. Because of this galvanic isolation, not only the high voltage outlet 11 is galvanically separated from the other components (i.e. solar cells 2 and three-phase alternating current cable 10), also the alternating current cable 10 and the solar cells 2 are galvanically separated from each other. Accordingly, two different potentials have to be defined in relation to the earth potential, namely the potential of the three-phase alternating current 6 and the potential of the direct voltage 5 at the solar cells 2.

Similar to the embodiment shown in FIG. 1, a first direct voltage source 16 that determines the potential of the neutral conductor 7 in relation to the earth potential serves the purpose of determining the potential of the three-phase alternating current 6. In this manner, also the potentials of the other phases (or lines) of the three-phase alternating voltage 6 are determined. On the galvanically independent solar cell side of the inverter 15 is now arranged a second direct voltage source 17 that can be made independently of the first direct voltage source 16. The second direct voltage source 17 controls the electric potential of the direct voltage 5 across an electrical connection to the direct current cable 3 that deflects the current of the solar cells 2. In particular, it is possible that the electric potential of the positive or negative voltage outlet of the solar cells 2 is determined, which also causes determination of the potential of the positive or negative outlet of the solar cells 2.

The first direct voltage source 16 and the second direct voltage source 17 can preferably be controlled independently of each other. However, the two direct voltage sources 16, 17 can have substantially the same embodiment. Further, the embodiment can be similar to the embodiment of the direct voltage source 12 shown in FIG. 1.

Also in the present embodiment, the two direct voltage sources 16, 17 are arranged in a partial area inside the substation 8 that is separated from the space of the transformer 9 by an intermediate wall 13. The advantages described above occur in an analogue manner. In some cases, the shown arrangement can be slightly problematic in that the copper cables 3 between solar cells 2 and inverter 15 now have a larger length. Therefore, it is also possible to provide the alternative outer wall 19 of the substation 8 instead of the left outer wall 18 shown in FIG. 2. In this case, the inverter 15 and the second voltage source 17 are arranged on the outside. In particular, it is possible to make the second voltage source 17 together with the inverter 15 in a common housing.

First tests have shown, however, that arranging transformer 9, inverter 15 and voltage source 16 and/or voltage source 17 adjacent to each other inside the substation 8 can even provide advantages with regard to the energy losses occurring. The copper cable 3 between solar cells 2 and inverter 15 will then be relatively long (the alternating current cable 10 will accordingly, however, be significantly shorter). However, the inventors have established that using an inverter 15 that performs no (additional) voltage transformation (i.e. particularly using galvanically non-isolating inverters 15) will cause a certain transformer loss, so that the voltage before the inverter 15 (i.e. in the copper cable 3) is higher than the voltage after the inverter 15 (i.e. in the alternating current cable 10). Accordingly, a “long” copper cable 3 (with correspondingly shorter alternating current cable 10) can even be particularly advantageous with regard to the inevitably occurring losses. This advantage can, of course, occur no matter if only one single direct voltage source 12 is available (as in the embodiment according to FIG. 1) or if a plurality of direct voltage sources 16, 17, 17′ . . . is available. Merely for reasons of completeness, it must be noted that the second direct voltage source 17 can also be arranged at a different location 17′, where the direct voltage source 17′ determines the potential of the plus-side of the solar cells 2 (and thus also the potential of the minus-side of the solar cells 2).

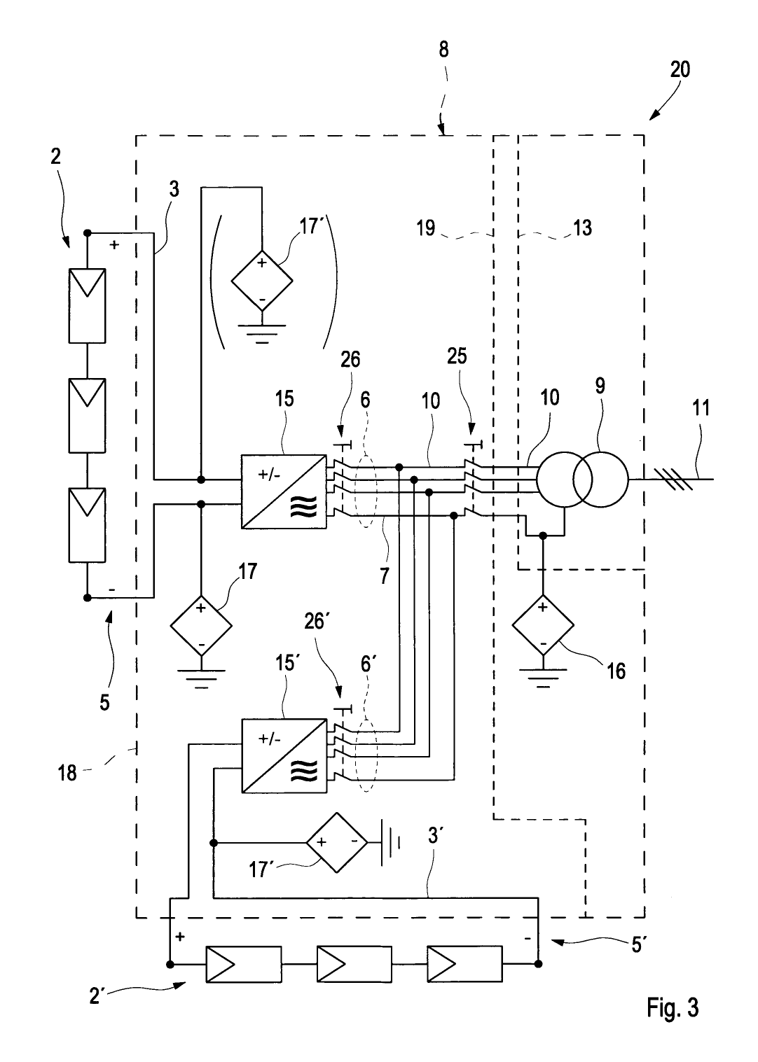

As a variation of the embodiment according to FIG. 2, FIG. 3 shows a schematic view of a third embodiment of a solar power plant 20. The third embodiment of a solar power plant 20 very much resembles the solar power plant 14 shown in FIG. 2.

The presently shown solar power plant 20 has, however, a larger number of solar cells 2, 2′. In order to prevent an excessive enlargement of the inverter 15, a second inverter 15′ is provided that converts the direct current 5′ supplied by the second solar cell unit 2′ to a three-phase alternating current 6′. The two inverters 15, 15′ are connected in parallel to each other, so that the current intensities of the two three-phase alternating currents 6, 6′ are added. In total, a larger output is thus available at the high voltage outlet 11 of the solar power plant 20. For this purpose, each inverter 15, 15′ is of course made so that it takes the phase angle of the other inverter 15′, 15 into consideration.

As the two inverters 15, 15′ are made as galvanically isolating inverters 15, 15′, the potentials of the two direct voltages 5, 5′ and the three-phase alternating currents 6, 6′ can be defined independently of each other. The direct voltage sources 16, 17, 17′ shown in FIG. 3 serve the purpose of defining the potentials. Of course, it is (particularly at a higher output power of the solar power plant 20) also possible to provide a larger number of inverters 15, 15′ (including the “related” components).

Finally, FIG. 4 shows a typical embodiment of a substation 8 from different directions.

FIG. 4b shows a front-view of the substation 8, in which the (lockable) door 21 is shown (preferably with two door panels). FIG. 4d shows that also the rear side can be provided with a door 21. The FIGS. 4c and 4e show the side walls of the substation 8. In the area of the side wall, FIG. 4e additionally shows a latched ventilation grille 22 for cooling purposes. As can be seen from FIGS. 4b-4e, the substation 8 is partly lowered into the ground 23.

Further, FIG. 3 shows first and second electrical contactors 25, 26, 26′, in the present case in the form of 4-way contactors 25, 26, 26′. With the electrical contactor 25 it is possible to separate the transformer 9 electrically from the alternating current cable 10. In this connection, the first direct voltage source 16 is arranged before the first electrical contactor 25 on the transformer side. When the first electrical contactor 25 is opened, the alternating current cable 10 is at the same time electrically separated from the electrical direct voltage of the first direct voltage source 16. This is particularly advantageous under the aspect of job safety.

Each of the second electrical contactors 26, 26′ is placed near the inverters 15, 15′ between the inverters 15, 15′ and the alternating current cable 10 (alternating current bus). This makes it possible to separate individual inverters 15, 15′ including all subsequent plant parts (particularly direct current cables 3, 3′ and solar cells 2, 2′) from the “main plant part” of the solar power plant 20. This provides a simple way of servicing or replacing the corresponding plant part (for example the inverter 15, 15′ concerned) without having to turn off the whole solar power plant 20. This is particularly economical, and also particularly advantageous under the aspect of job safety. Besides, it is possible that the control signal for the control of the corresponding second electrical contactor 26, 26′ at the same time also disconnects the corresponding second direct voltage source 17, 17′.

For reasons of completeness, it must be noted that in one variation of the solar power plant 20 shown in FIG. 3, it is possible to use non galvanically isolating inverters instead of the galvanically isolating inverters 15, 15′. In such an embodiment, basically one single direct voltage source 16, 17, 17′ is required for the whole solar power plant 20. In this case, it is particularly advantageous to arrange the direct voltage source at the location of the first direct voltage source 16 shown in FIG. 3. Here, the disconnection of one single, namely the first electrical contactor 25 can switch the whole solar power plant 20 free of direct voltage. Otherwise, it would in some cases be necessary to switch a larger number of or all the second electrical contactors 26, 26′ to achieve the direct voltage-free state. It must be noted that, when switching off the first electrical contactor 25, the solar power plant 20 generates no further electrical energy anyway. Therefore, turning off only individual plant parts 2, 2′, 3, 3′, 15, 15′ therefore makes no sense.

FIG. 4a shows a schematic, cross-sectional top view of the substation 8. The doors 21 located at the front side and the rear side of the substation 8 can be seen. In a partial area 24 of the substation 8, the transformer 9 is located. By means of an intermediate wall 13, a partial space 24 of the substation occurs, in which particularly the direct voltage source or the direct voltage sources 16, 17, 17′, 12 and under certain circumstances also further components can be arranged.

Although various embodiments of the present invention have been described and shown, the invention is not restricted thereto, but may also be embodied in other ways within the scope of the subject-matter defined in the following claims.

What is claimed is:

1-11. (canceled)

12. An arrangement with at least one electric potential-varying device for varying the electric potential of at least one electrical device in relation to earth potential, comprising a plurality of photovoltaic cells and at least one plant room facility, the electric potential-varying device as well as at least one transformer device being at least partly arranged in the at least one plant room facility during operation, characterised in that at least parts of the photovoltaic cells are grouped electrically in such a way that, at least in certain areas, the individual groups comprise different current paths for the generated current.

13. The arrangement according to claim 12, wherein the at least one plant room facility is made at least partly as a building facility and/or lockable facility and/or at a central location.

14. The arrangement according to claim 12, wherein the at least one plant room facility serves the purpose of at least partly accommodating further components, in particular inverter devices.

15. The arrangement according to claim 12, wherein the at least one plant room facility serves the purpose of at least partly accommodating at least one transformer device and at least one inverter device.

16. The arrangement according to claim 12, wherein at least parts of a photovoltaic plant, for example at least one transformer device, at least one inverter device, at least one photovoltaic cell module, at least one photovoltaic cell panel and or at least one, preferably designed to be movable, support device, in particular for at least one photovoltaic cell, at least one photovoltaic cell module and/or at least one photovoltaic cell panel, preferable characterised in that the arrangement is made as a photovoltaic power plant.

17. The arrangement according to claim 16, wherein the at least one inverter device is made as a galvanically isolating inverter device and as a galvanically non-isolating inverter device and/or as a two-phase alternating current generating inverter device and as a three-phase alternating current generating inverter device and as a multi-phase alternating current generating inverter device.

18. The arrangement according to claim 12, wherein the electric potential of at least one negative voltage line and/or at least one positive voltage line and/or at least one alternating voltage line and at least one neutral conductor line is varied.

19. The arrangement according to claim 12, wherein at least partly and/or at least in certain areas, the size of the potential displacement is changeable, at least partly and/or at least with regard to range, and is particularly time dependent, light-intensity dependent, temperature dependent, voltage dependent, current dependent and/or depends on the control input via an interface device.

20. The arrangement according to claim 15, wherein at least parts of the photovoltaic cell modules and/or at least parts of the photovoltaic cell panels are grouped electrically in such a manner that at least in certain areas the individual groups have different current paths for the generated current.

21. The arrangement according to claim 15, wherein at least parts of at least one inverter are arranged adjacent to at least one photovoltaic device.

22. The arrangement according to claim 12, wherein at least one switching device and/or at least one safety device, at least one electric potential-varying device preferably being arranged between the at least one switching device and/or the at least one safety device and at least one electrical device, for example in particular at least one transformer device and/or at least one inverter device.
